(19) United States
(12) Patent Application Publication
(10) Pub. No.: US 2024/0237676 A1
(43) Pub. Date: Jul. 18, 2024

(54) ANIMAL FEED LIMITER

(71) Applicant: John I. Haas, Inc., Yakima, WA (US)

(72) Inventors: Mark Griffin, Hohenwald, TN (US); Alexander A. Byelashov, Gig Harbor, WA (US)

(21) Appl. No.: 18/543,646

(22) Filed: Dec. 18, 2023

Related U.S. Application Data
(60) Provisional application No. 63/480,370, filed on Jan. 18, 2023.

(51) Int. Cl. A23K 10/37; A23K 20/158; A23K 50/10

(52) U.S. Cl. CPC A23K 10/37; A23K 20/158; A23K 50/10

(57) ABSTRACT

An animal feed limiter (inhibitor) and methods of making and using the limiter are provided.

### CROSS REFERENCE TO RELATED APPLICATIONS

This application claims priority to U.S. Provisional Application No. 63/480,370, filed Jan. 18, 2023, the disclosure of which is incorporated herein by reference in its entirety.

### FIELD OF THE INVENTION

The invention resides in the field of hop-based products as animal feed intake limiters for livestock.

### BACKGROUND OF THE INVENTION

In the feeding of animals on pasture, particularly cattle, it is often very advantageous from the standpoint of economics, as well as convenience, for the cattle to be self-fed, which means that the cattle are offered a feed or feed supplement on a free choice basis without periodic feedings of a rationed amount by a farmer or rancher each day. An exemplary feed supplement is a high energy grain source such as corn, grain, sorghum, barley, wheat, etc., and properly balanced for protein, minerals, and vitamins. A disadvantage, however, of self-feeding animals such as cattle is that the animals tend to over-eat feed supplements, consuming all that is provided to them in a short amount of time, and consequently get a higher intake of supplement than is completely necessary for proper performance, weight gain, or weight maintenance over a given time period. This results in an additional expense for the rancher in having to provide a daily rationed amount of feed supplement, often over large distances, in combination with a roughage source such as grass or hay and other naturally-available forage on the range or in the pasture. It is, therefore, desirable to limit the intake of the feed supplement to an amount which is the proper amount needed for performance, weight gain, or weight maintenance on a daily basis without rapid consumption of more than is needed by the animal.

In another context, those beef cattle maintained for reproductive purposes normally live on ingested forage consisting of large amounts of cellulose and are supplemented with additional protein, energy, minerals, and vitamins when nutrients in forages do not meet nutritional needs of the reproducing animals. However, the offspring from these cattle, which are being produced for slaughter, will normally be placed in a confined feeding facility (feed lot) at 7-15 months of age, and fed growing diets, consisting of 30-60% roughage, and/or finishing diets, consisting of only 5-15% roughage. The roughage will normally be in the form of hay, silage, fodder, corn cobs, cottonseed hulls, etc. The remainder of the diet will consist of a feed supplement.

What is needed in the art is a livestock feed supplement containing a component causing the animal to self-limit its feed intake over a given unit of time when presented with a feed supplement on a free choice basis.

Prior feed limiters have incorporated various chemical agents, e.g., salt or gypsum, in the feed supplement in order to control consumption of the supplement to a prescribed amount over a given time period. A disadvantage, however, in employing either one of these compounds to control consumption of the supplement and provide an effective self-limiting feed composition is that such materials provide little to no nutritional value and require mixing in large quantities with the supplement in order to reduce consumption thereof. For example, one part of salt to three parts of protein or feed supplement will ordinarily be required to reduce daily consumption in cattle to the desired amount. Another disadvantage of employing these materials is that salt poisoning (or poisoning by an alternative feed limiter) of the animals may occur if water is not freely available.

U.S. Pat. No. 3,669,676 provides a feed intake limiting composition for cattle comprising a mixture of fish oil, ammonium sulfate, diammonium phosphate, and meat meal. This mixture can be added to a feed supplement, which can then be offered on a free-choice basis to cattle in combination with a roughage source such as grass or hay. While this composition has proven to be effective as an intake limiter, the cost and availability of certain components of the mixture as well as a continuing need for other limiters, which can effectively control intake to a prescribed degree and also contribute to the nutritive properties of the feed supplement, are clear shortcomings.

Other non-salt feed limiters are known. See, e.g., U.S. Pat. No. 4,230,736, describing an intake limiting feed containing an intake limiting amount of a chlorinated fat; U.S. Pat. No. 4,686,205, describing an intake limiting feed containing sucrose octaacetate; U.S. Pat. No. 5,378,477, describing a feed devoid of roughage and supplemented with an oil.

Certain feed limiters include toxic compounds, such as sodium hydroxide or calcium hydroxide, carrying the risk of sickening the animal to which they are fed. See, U.S. Pat. Nos. 4,895,728, and 4,900,562, respectively.

As set out above, it is desirable to limit the intake of the non-roughage feed supplement so that rapid over-consumption of the supplement does not occur. Incorporating intake limiters into supplements has been used for this purpose. Many of the previous feed intake limiters require metering and/or special equipment to control their administration, have relied on adding chemically modified substances of indeterminate effect on the animal, add known toxic substances to an animal feed supplement, or are otherwise less than fully desirable. Generally, prior feed limiters impart no or insignificant nutritional value to the feed supplement and may carry a tangible risk of harm to the animal.

A feed intake limiter avoiding the shortcomings noted above would represent a significant advance in this field. The feed intake limiting composition of the present invention addresses these shortcomings and provides certain unexpected advantages.

### BRIEF SUMMARY OF THE INVENTION

In various embodiments, the present invention relates to a hop-based feed intake limiting composition for livestock and a process for employing the same in order to attain an economical and efficient means of controlling the feed supplement intake of self-feeding livestock, e.g., cattle, or other livestock, in a confined feeding facility or on pasture. The inventors have found that hop products, e.g., pelletized and debittered hop cones, hop resins, hop oils and combinations of these products, have an unexpectedly efficacious effect on limiting animal feed intake over a given time period when incorporated into an animal feed.

Furthermore, the hop-derived feed limiter has inherent nutritional value for the livestock and is largely derived from feedstock taken from a waste stream, imparting a secondary use to a material that would otherwise be composted, sent to an incinerator, or otherwise destroyed. Thus, the present invention provides significant benefits in terms of animal health, economics, and preventing unnecessary waste of a material not previously recognized as useful; these advantages are not provided by prior feed limiters.

In various embodiments, the invention provides a hop-derived animal feed limiter comprising a source of hop solids, e.g., debittered hop cones, with or without one or more preparation of hop oils, hop resins, or a combination thereof. In an exemplary embodiment, the hop-derived animal feed limiter is incorporated into an animal feed supplement, providing a self-limiting feed supplement, to reduce intake of the feed supplement by an animal over a given time period, e.g., reduce the mass of feed supplement consumed over a given time period.

An exemplary feed intake limiter is a hop-based feed intake limiter comprising a source of hop solids, e.g., debittered hop cones, that are generated from the extraction or mechanical processing of hop cones.

An exemplary feed intake limiter is a hop-based feed intake limiter comprising: a source of hop solids, e.g., debittered hop cones, mixed with from about 0.5% (wt/wt) to about 50% (wt/wt) of oil enriched hop extract, the extract comprising from about 20% (wt/wt) to about 40% (wt/wt) hop oils.

An exemplary feed intake limiter is a hop-based feed intake limiter comprising: a source of hop solids, e.g., debittered hop cones mixed with from about 0.5% (wt/wt) to about 50% (wt/wt) of oil enriched hop extract, the extract comprising from about 60% (wt/wt) to about 80% (wt/wt) hop resins.

In an exemplary embodiment, the invention provides an intake self-limiting animal feed supplement comprising a mixture of (a) a feed supplement component; and (b) a feed intake limiting component comprising hops solids, wherein the feed supplement component and the feed intake limiting component are mixed together, forming the intake self-limiting animal feed supplement.

In some embodiments, the invention provides an animal feed supplement, comprising a feed intake limiting amount of a hop-based feed intake limiting component, the feed limiting component comprising: a source of hop solids, e.g., debittered hop cones, mixed with from about 0.5% (wt/wt) to about 50% (wt/wt) of oil enriched hop extract, the extract comprising from about 20% (wt/wt) to about 40% (wt/wt) hop oils, with the remainder substantially comprising hop resins. The presence of the feed limiting component results in the animal consuming less of the feed supplement over a given time period.

In an exemplary embodiment, there is provided a kit for making the intake self-limiting animal feed supplement of the invention, the kit comprising: (a) the feed intake limiting component comprising hops solids; and (b) instructions for combining the feed intake limiting component and the feed supplement to make the intake self-limiting animal feed supplement.

Also provided, in an exemplary embodiment, is a kit comprising a hop-based animal feed intake limiter comprising: (a) a source of hop solids, e.g., debittered hop cones, mixed with from about 0.5% (wt/wt) to about 50% (wt/wt) of oil enriched hop extract, the extract comprising from about 20% (wt/wt) to about 40% (wt/wt) hop oils; and (b) instructions for combining a feed intake limiting amount of the animal feed intake limiter with an animal feed supplement to formulate a feed intake limiting animal feed supplement. An exemplary kit includes a feed supplement combined with the hop-derived feed intake limiter. An exemplary kit includes a container holding a pre-determined amount of animal feed supplement and a second container holding a pre-determined amount of the feed limiter, which, when the two are mixed together according to the instructions, provide a feed supplement with a useful balance of feed supplement to feed intake limiter.

In an exemplary embodiment, there is provided a method of making the animal feed supplement described herein. The method comprises combining the hop product-based feed intake limiter of the invention with an animal feed supplement. The feed limiter and the feed supplement are combined in a ratio sufficient to provide a determined feed limiting effect. The feed limiting effect is readily determined by monitoring feed intake by livestock receiving the feed limiter and comparing this intake to the intake of similar animals not receiving the feed limiter over a given time period. In an exemplary embodiment, the difference in feed supplement intake is determined by a difference in relative mass of intake over a given period of time.

In various embodiments, there is also provided a method of reducing feed supplement intake in livestock. The method includes feeding the livestock a feed intake limiter comprising a source of hop solids, e.g., debittered hop cones, in a combination with a feed supplement. In various embodiments, the source of hop solids is mixed with hop oils, hop resins, or a combination thereof either alone or in combination with a feed. An exemplary hop oil/resin mixture is from about 20% (wt/wt) to about 40% (wt/wt) oils with the remainder of the mixture being hop resins. In various embodiments, the feed intake by the animal is reduced by at least about 5%, at least about 10% (wt/wt), at least about 20% (wt/wt), at least about 30% (wt/wt), at least about 40% (wt/wt), or at least about 50% (wt/wt) when compared to a similar animal that was not fed supplement with the feed intake limiter. In an exemplary embodiment, the reduced intake is measured by comparing relative mass of intake of an animal fed the feed supplement/intake limiter, and one fed only the feed supplement (or the feed supplement and a lower mass of the limiter) over a given period of time.

The above materials and methods are not only effective in limiting feed intake over a given time period, they also do not detract from or destroy the nutritional balance of the feed supplement. In fact, in various embodiments, the feed limiter augments the nutritional content of the feed supplement. The disclosed feed limiter composition does not require feeding in a large quantity and provides a convenient and economical means of limiting the feed supplement intake in livestock, when incorporated into the feed supplement. An object, therefore, of the present invention is to provide a composition which consists of components which individually do not detract from the nutrient composition of the feed supplement, while at the same time effectively limit feed supplement intake to a predetermined amount in order to allow self-feeding of the livestock. It is also an object of the present invention to provide a method for limiting feed supplement intake by livestock by feeding a composition comprising various materials which individually add to the nutrient requirements of the animal, yet effectively limit supplement intake over a given time period when combined with a roughage source to provide a convenient and economical means of feeding livestock.

Accordingly, Applicant has addressed and solved shortcomings and problems associated with previous animal feed intake limiters.

Further embodiments and objects of the invention are apparent from review of the Detailed Description following.

### DESCRIPTION OF THE DRAWINGS

FIG. 1 is a flow diagram showing products downstream from hop pellets following supercritical CO₂ extraction (Product A, Product B, Hop Acids, Oil Enriched Hop Extract, and Hop Oils).

FIG. 2 is a flow diagram showing products downstream from sieved hop cones (Product C and Product D).

### DETAILED DESCRIPTION OF THE INVENTION

### I. Introduction

In accordance with certain aspects of the present invention, Applicant has developed a hop-based animal feed limiting product, a method for making this feed limiting product, a method for limiting free choice feed consumption by animals over a given time period, and a method of preparing a feed which is self-limiting when consumed by the animal. To establish and retain consistency of feeding in livestock maintained on feed incorporating a feed supplement is a challenge inherent in providing a practical and effective self-limiting animal feed. Critically, the self-limiting feed must be accepted and consumed by the animals to which it is fed. Further, the self-limiting feed preferably does not bring about any deleterious effects on the animals consuming it, e.g., erratic intake, starch overload, harmful change in rumen microflora, bloat, founder, liver abscesses, kidney lesions, rumen parakeratosis, abomasal ulcer, and death.

In accordance with exemplary embodiments of the present invention, a hop-based feed limiting composition has been developed which is capable of limiting feed supplement intake in livestock to a predetermined amount necessary for proper weight maintenance of the livestock, e.g., ruminants. This predetermined amount of feed intake for livestock will accordingly vary depending on the type of animals as well as the environmental conditions under which they are maintained and is, therefore, not intended to limit the present invention although, it may be generally considered that a typical feed intake limitation for a feed supplement in conjunction with the hop-based feed limiter will be less than about 6 lbs of supplement per head per day, preferably less than 4 lbs. per head per day, and usually between about 1 to 4 lbs of supplement per head per day. A preferred amount of feed supplement intake (modulated by the feed intake inhibitor) will generally be the amount necessary for proper weight maintenance as well as the most efficient feed utilization by the animal. In an exemplary embodiment, the livestock is cattle.

By way of illustration, depending on numerous variables, cows often eat about 2% body weight/day of roughage/pasture. Accordingly, a 1000 lbs cow would eat about 20 lbs of hay (much more fresh grass as it has a higher water content). An exemplary cow on pasture may eat 2 lbs of supplement and 20 lb or more of dry matter roughage. For high performance dairy cows, many breeds are larger and eat more, approximately 50 or more lbs per head per day of dry matter.

When the present disclosure refers to a reduction in the amount of feed supplement consumed by an animal when the feed supplement is combined with the inventive feed intake limiter, it should be understood that this reduction is due to an affirmative feed limiting effect of the feed and is not attributable to administering less feed supplement to the animals with a difference in the weight/volume of the feed supplement being made up by a corresponding weight/volume of the inventive hop-based feed intake limiter. Accordingly, in an exemplary embodiment in which the animal is offered the same amount of feed supplement alone and in a mixture with the feed intake limiter, the animal will not consume the same weight/volume of feed supplement from the mixture of feed supplement and feed limiter over a given period of time as it consumes when only feed supplement is offered for the same time period.

In an exemplary embodiment, the feed intake limiter is an “intake self-limiting” feed limiter. As the term, “intake self-limiting” is used herein, it refers to a feed intake limiter causing an animal to cease eating a feed supplement before the entire quantity of feed supplement is consumed. By way of clarifying, this does not refer to a scenario in which an animal is offered such a large quantity of feed supplement that it ceases feeding because it is “full”; rather, a quantity of feed supplement offered to an animal is substantially the same quantity of the same feed supplement that would be offered a substantially identical animal for the same purpose, which quantity would, in the absence of the intake limiter, be completely consumed within a selected time period.

In an exemplary embodiment, an animal offered a quantity of feed supplement containing the feed limiter will cease feeding before the quantity of feed supplement is exhausted. By comparison, a second substantially identical animal fed the same quantity of the same feed supplement without the intake limiter will continue to feed until the quantity of feed supplement is exhausted. In various embodiments, when the first and second animals are offered the same quantity of the same feed supplement for the same selected time, the first animal will have consumed less of the feed supplement than the second animal during the selected time. In various embodiments, the selected time period is the time it takes the second animal to consume the entire quantity of the feed supplement. Accordingly, in the selected time period, the second animal has consumed all of the feed supplement offered while the first animal has not consumed the entire quantity of feed supplement and feed limiter. In this manner, the feed intake limiter of the invention is an “intake self-limiting” feed intake limiter.

In an exemplary embodiment, per offering, the animal consumes less of the mixture of feed supplement combined with feed intake limiter than feed supplement alone over a given time period. Exemplary feed limiters of the invention do not serve to simply expand the volume of a lower amount of feed supplement with a hops-based non-feed supplement component so that a lower weight/volume of feed supplement can be offered. The feed intake limiter of the invention is not a volume expander or filler, it is a functional ingredient that deters rapid overeating by the animal. For example, an animal which will consume an entire administered weight/volume of feed supplement (X kg) without added feed limiter will consume a lower weight/volume of the feed supplement (X kg-Y kg) when the same amount of feed supplement (X kg) is mixed with the feed intake inhibitor.

In an exemplary embodiment, when a mixture of feed supplement and feed intake limiter is offered, the animal will consume a lower weight/volume of the mixture over a given time period than of the feed supplement alone when the feed supplement+feed limiter and the feed supplement alone are offered in equivalent amounts. As demonstrated in the Examples, when equivalent amounts of feed supplement and feed supplement combined with feed intake limiter are administered to an animal, the animal consumes less of the combined mixture over a given time period than of the feed supplement alone.

### II. Embodiments

### A. Compositions

In exemplary embodiments, there is provided an animal feed intake limiter and also an animal feed comprising a feed intake limiting component of the invention comprising hop solids, e.g., debittered hop cones. The hop solids can be in any physical format, e.g., ground, powdered, pellets, or blocks. In an exemplary embodiment, the hop solids are pelletized. The feed intake limiter is combined with a feed supplement for the animal, the feed intake limiter, thereby reducing intake by the animal of the feed supplement over a given time period. The amount the feed supplement intake is reduced is, in some embodiments, proportional or dependent upon the amount of feed intake limiter added to the feed supplement. Accordingly, in some embodiments, the amount of time that an animal takes to consume the feed supplement can be controlled by the amount of the hop-based feed intake limiter added to the supplement, and the feed supplement can also be rationally “dosed” with the feed intake limiter to adjust intake of feed supplement to a desired level.

### (1) Hop Solids

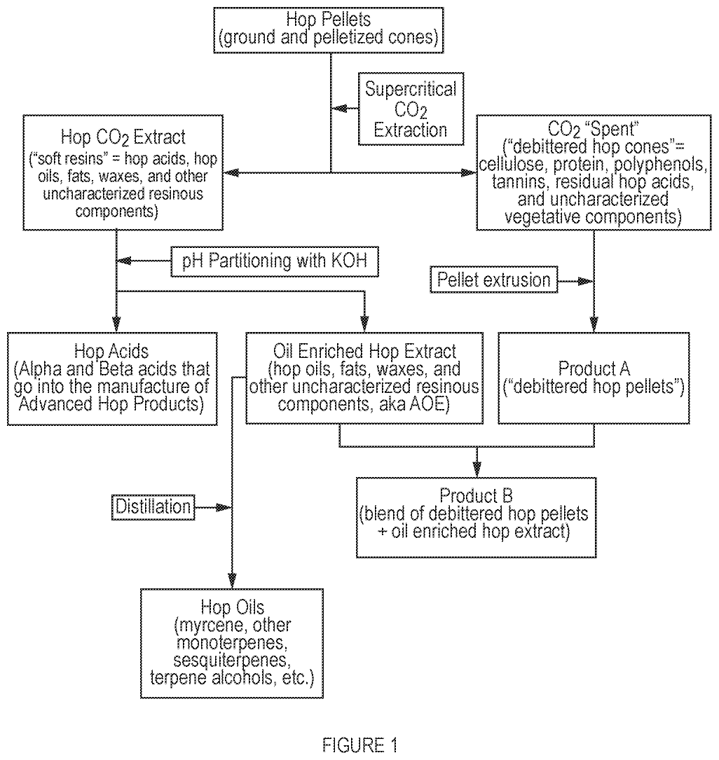

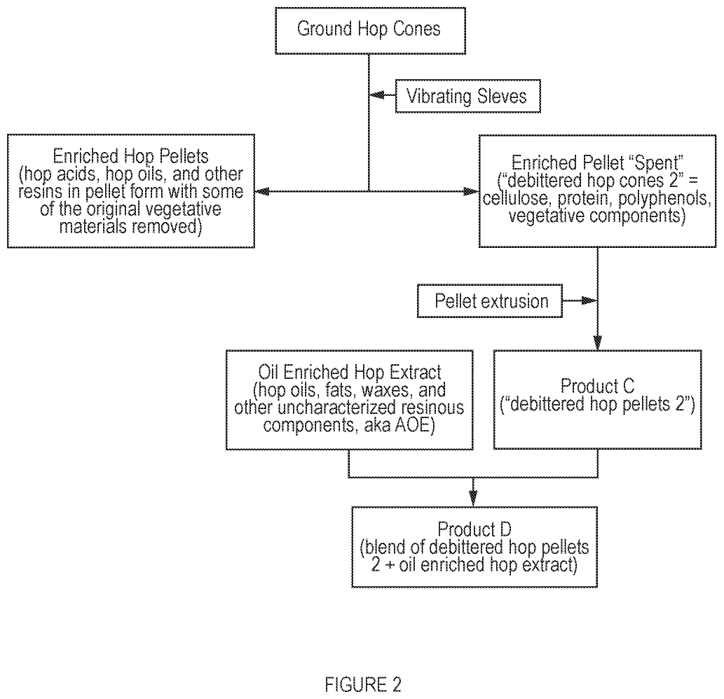

The present invention can be practiced with hop solids from substantially any source and in any format. Exemplary hop solids of use in the invention are set forth below. The hop solids of use in the invention are not limited to the exemplars provided herein. FIG. 1 and FIG. 2 provide a schematic diagram of the origins of the various hop solids and other hop products of use in the compositions and methods disclosed herein.

A. “Spent” Hopsfrom CO₂ Extraction. Referred to herein as, “debittered hop cones”, this material is generated during the manufacturing of hop extracts. During the process, hop “resins” are removed. “Resin”, as used herein is a broad term for a material including the hop acids (alpha and beta), hop oils, hop fats and waxes, and other uncharacterized resinous components. The “spent” debittered hop cones that are left contain cellulose, polyphenols, tannins, and other components that are not dissolved by supercritical CO₂. While the “spent” is typically a powder after extraction, the “spent” solid is typically pelletized for storage and handling.

B. “Spent” Hops from CO₂ Extraction with Added Hop Resins/Oil. This material is hop solids Product A, above, mixed with a hop oil extract, e.g., AromaHop® Oil Extract (AOE) (John I. Haas, Yakima, WA). AOE is a product of hop acid processing. In simplest terms, the alpha acids and beta acids in a CO₂ hop extract are removed and processed further. What remains after removal of the hop acid is AOE. This contains the hop oils and other resin components (fats, waxes, etc.).

C. “Spent” Hop Material from Enriched Pellet Manufacturing. When standard hop pellets are produced, hop cones are ground into a powder and then put through a die that extrudes them into a pellet form. These are typically referred to as T90 pellets. Another form of hop pellet is generated by taking the powdered hop cones and sending the material through a series of vibrating sieves at approximately −30° C. In the process, the solids containing the soft hop resins (oils and acids responsible for flavor and bitterness) are separated from the rest of the vegetative material. The solid containing the resins are pelletized and are known as “enriched” pellets since some of the hop cone has been removed. The “spent” that has been removed represents another material stream of use as the feed intake limiter of the invention. This material is a “debittered hop cone”, but different than the “spent” material after CO₂ extraction.

D. “Spent” Hop Material from Enriched Pellet Manufacturing with Added Hop Resins/Oil.

This is hop solids Product C, above, mixed with AOE.

E. Hop Pellets. Standard T90 hop pellets that are used in brewing.

### (2) The Animal Feed Intake Limiter

In an exemplary embodiment, the animal feed intake limiter includes a source of hop solids such as those set forth hereinabove. In various embodiments, the source of hop solids is mixed with an animal feed supplement, thereby forming a self-limiting feed supplement of the invention. In various embodiments, the hop solids account for from about 0.5% (wt/wt) to about 20% (wt/wt), e.g., from about 2% (wt/wt) to about 15% (wt/wt), e.g., from about 5% (wt/wt) to about 10% (wt/wt) of the weight of the feed supplement/feed limiter composition. In various embodiments, the hop solids account for about 1%, 2%, 3%, 4%, 5%, 6%, 7%, 8%, 9%, 10%, 11%, 12%, 13%, 14% or about 15% of the weight of the feed supplement/feed limiter composition, all (wt/wt).

In various embodiments, the animal feed intake limiter further includes hop extracts mixed with the hop solids. The hop extracts are present in the feed limiter in any useful amount to effect the desired feed limiting properties of the composition. In exemplary embodiments, the hop extracts are present in from about 0.5% (w/w) to about 50% (w/w) of the feed intake limiter. In some embodiments, the hop extract is present at about 1% (w/w) to about 25% (w/w), e.g., from about 2% (wt/wt) to about 15% (wt/wt), e.g., from about 5% (w/w) to about 10% (w/w) of the feed intake limiter. In an exemplary embodiment, the hop extract is an oil enriched hop extract.

An exemplary hop extract includes hop resins, which comprise hop oils, acids, e.g., alpha and beta acids, fats, and waxes. An “oil enriched hop extract”, as this term is used herein, refers to a hop extract from which the hop acids have been removed, resulting in a composition with a higher relative oil content by weight than the precursor extract containing the acids. FIG. 1.

The hop extract may be derived from any source, however, in various embodiments, the extract comprises hop oils. In an exemplary embodiment, the extract comprises from about 20% (wt/wt) to about 40% (wt/wt) hop oils, e.g., about 25% (wt/wt), about 30% (wt/wt), about 35% (wt/wt), or about 40% (wt/wt) hop oils, and the remainder of the extract is other non-oil hop resin components.

Any hop extract achieving the result of limiting animal feed intake, when mixed with a hop solid, is of use in the invention. In an exemplary embodiment, the hop oils in the extract are at least partially selected from the monoterpene myrcene, the sesquiterpenes humulene and caryophyllene, other terpene-derived components, and a combination thereof.

An exemplary animal feed limiter of the invention has been granted approval by FDA as a food additive, approved by the American Association of Feed Control Officials (AAFCO), certified as GRAS, or a combination thereof. An exemplary kit of the invention includes notice of this designation in the instructions and/or packaging for the feed limiter or feed supplements into which the feed limiter is incorporated.

In an exemplary embodiment, the animal feed limiter is incorporated into an animal feed supplement to a predetermined amount, which is effective for proper weight maintenance of a selected livestock animal, e.g., cattle. This predetermined amount of feed limiter for an animal will accordingly vary depending on the type of animals, size and maturity of the animals, as well as the environmental conditions under which they are maintained and is, therefore, not intended to limit the present invention.

The feed limiter can be added to a feed supplement, or the components of the claimed composition may be mixed individually with the feed supplement in predetermined amounts. In an exemplary embodiment, the components of the feed limiter are mixed with the feed supplement to obtain the desired ratio of hop solids:feed supplement, the ratios of hop solids:hop oils, or hop solids:hop resins, or the ratios of hop solids:hop oils:feed supplement or hop solids:hop resins:feed supplement set forth herein.

The basal portion of the feed supplement may be any standard ration, for example, a standard nutritional supplement such as the liquid feed supplement described in U.S. Pat. No. 4,285,974. A nutritional supplement in block form may be used, such as descried in U.S. Pat. No. 4,171,385, or any standard formulation for animal rations in meal, pellet, and cubed form, as is known in the art.

Furthermore, the feed supplement to which the intake limiting composition of the present invention may be added, may be any liquid or ‘grain’ type supplement which is generally intended to provide the full nutritional requirements of the animal, with the exception of, as in the case of cattle, the various roughage sources which are considered to be necessary for proper feed utilization. Therefore, “grain” type feeds to which the intake limiting compositions of the present invention may be added, may consist of various grains which are predominately farinaceous or proteinaceous as the case may be. Included among these suitable proteinaceous materials are the vegetable proteins such as soybeans, cottonseed, or peanuts. These are considered to be highly utilizable and available sources of protein for animals. Likewise, various farinaceous materials which contain a lower percentage of protein, but additionally contribute to the protein requirement of the feed, may also be employed among which are grains such as corn, milo, or various wheat materials or wheat by-products.

In an exemplary embodiment, there is provided an intake self-limiting animal feed supplement comprising a mixture of: (a) a feed supplement component; and (b) a feed intake limiting component comprising hops solids, wherein the feed supplement component and the feed intake limiting component are mixed together, forming the intake self-limiting animal feed supplement.

In various embodiments, the feed supplement component is selected from grains, legumes, nuts, seeds and a combination thereof.

In various embodiments, the hops solids are selected from spent hops from CO₂ extraction, spent hops from enriched pellet manufacturing, hop pellets and a combination thereof. In one embodiment, the hops solids are debittered hops cones.

In some embodiments, the intake self-limiting animal feed supplement includes a feed intake limiting component comprising a hop extract mixed with the hops solids.

In various embodiment, the hop extract comprises hop oils.

In some embodiments, the hop extract comprises from about 20% (wt/wt) to about 40% (wt/wt) hop oils.

In some embodiments, the hop extract is present in the feed intake limiting component in an amount of from 0.5% (w/w) to about 50% (w/w) of the feed intake limiting component.

An exemplary feed intake limiter is a hop-based feed intake limiter comprising: a source of hop solids, e.g., debittered hop cones, mixed with from about 0.5% to about 50% (wt/wt) of hop extract, the extract comprising from about 20% to about 40% (wt/wt) hop oils, and the remainder constituting hop resins. An exemplary hop extract is an oil enriched hop extract.

In various embodiments, there is provided a feed intake limiter, which is a hop-based feed intake limiter comprising: a source of hop solids, e.g., debittered hop cones, mixed with from about 0.5% to about 50% (wt/wt) of hop extract, the extract comprising from about 60% to about 80% (wt/wt) hop resins. An exemplary hop extract is an oil enriched hop extract.

In various embodiment, the hop extract comprises hop resins.

In some embodiments, the hop extract comprises from about 60% (wt/wt) to about 80% (wt/wt) hop resins.

In various embodiments, there is provided a feed intake limiter, which is a hop-based feed intake limiter comprising: a source of hop solids, e.g., debittered hop cones, mixed with from about 0.5% to about 50% (wt/wt) of hop extract, the extract comprising from about 60% to about 80% (wt/wt) hop resins. An exemplary hop extract is an oil enriched hop extract.

Also provided, in an exemplary embodiment, is a kit comprising a hop-based animal feed intake limiter comprising: (a) a source of hop solids, e.g., debittered hop cones; and (b) instructions for combining a feed intake limiting amount of the animal feed intake limiter with animal feed supplement to formulate a feed intake limiting animal feed supplement.

In some embodiments, the kit further comprises: (c) the feed supplement.

In various embodiments, the instructions in the kit direct the user how to mix the feed intaking limiting component and the feed supplement in a ratio selected to achieve a selected reduction in feed supplement intake by the animal.

In some embodiments, the instructions in the kit direct the user how to mix the feed intaking limiting component and the feed supplement in a ratio selected to achieve a selected reduction in feed supplement intake by the animal within a given time period.

In an exemplary embodiment, the invention provides a kit comprising a hop-based animal feed intake limiter comprising: (a) a source of hop solids, e.g., debittered hop cones, mixed with from about 0.5% to about 50% (wt/wt) of hop extract, the extract comprising from about 20% to about 40% (wt/wt) hop oils, the remainder constituting hop resins; and (b) instructions for combining a feed intake limiting amount of the animal feed intake limiter with animal feed supplement to formulate a feed intake limiting animal feed supplement. In an exemplary embodiment, the extract is an oil enriched extract.

An exemplary kit includes a feed supplement combined with the hop-derived feed intake limiter of the invention. In some embodiments, the instructions provide a guide to the user in the use of the kit contents to enable reduction of livestock feed supplement intake over a given time period by at least about 5%, at least about 10%, at least about 20%, at least about 30%, or more of the corresponding feed supplement intake of a similar livestock animal to which the feed limiter is not administered.

In various embodiments, the kit is in the form of a package containing the feed limiter or the feed limiter plus feed supplement, and directions for using the contents to reduce the feed supplement intake of selected livestock. In some embodiments, the instructions provide a guide to the user in the use of the package contents to enable reduction of livestock feed supplement intake over a given time period by at least about 5%, at least about 10%, at least about 20%, at least about 30%, or more of the corresponding feed supplement intake of a similar livestock animal to which the feed limiter is not administered.

In various embodiments, the feed supplement of the invention further includes a colloid material such as clay, including bentonite or attapulgite clay at typical levels. Exemplary levels are from about 0.5 to about 5% by weight. In some embodiments, the feed limiter and/or feed supplement includes a vegetable gum such as xanthan gum at a useful level. An exemplary level of the gum is from about 0.025 to about 0.015% by weight. In some embodiments of the present invention, there is also included a dispersing agent such as a soluble phosphate salt, for example, sodium, potassium, ammonium, tripolyphosphate, pyrophosphate and polyphosphates.

If desired, the feed limiter and/or the feed supplement may additionally contain various non-protein nitrogen materials such as urea or biuret or other sources of non-protein nitrogen which ruminant animals specifically utilize and convert to organic protein. This provides a cheap and effective source of nitrogen in a ruminant diet. The feed can also contain various minerals considered essential for proper weight maintenance of animals such as cattle as well as various vitamins either fat or water soluble, which typically are added to feed supplements for complete nutritional balance. A liquid feed medium suitable for use in the present invention generally comprises a liquid medium such as molasses or a liquid carbohydrate solution or a medium including materials such as sugars, pectins, dextrins, starches or other types of soluble carbohydrate materials.

A further ingredient which may be employed in the present invention, if desired, are various medicaments or additives to the feed supplement either for the purpose of disease control or for improving performance. Materials of this type include additives such as antibiotics, bacteriostats, hormones, and the like. For the most effective results, a feed supplement will be fed to the cattle in combination with various cellulosic roughage sources to be used in combination with the feed supplement containing the intake limiting composition. It should be recognized that the particular roughage source which may be utilized in the present invention will be generally dictated by local availability of various forage crops.

### B. Methods

In various embodiments, there is provided a method of reducing feed intake in livestock, the method comprising, feeding the livestock the feed intake limiter of the invention. In an exemplary embodiment, the feed intake limiter comprises debittered hop cones.

In an exemplary embodiment, the invention provides a method of inhibiting feed supplement intake by a livestock animal, the method comprising: feeding the animal a mixture comprising a first amount of a feed supplement combined with a feed intake inhibitor, the inhibitor comprising a source of hop solids, thereby inhibiting the feed supplement intake over a given time period relative to uptake by the same or similar animal of the feed supplement alone without the limiter.

In an exemplary embodiment, there is provided a method of detectably inhibiting feed supplement intake by a livestock animal, the method comprising, feeding the animal a mixture comprising a first amount of a feed supplement combined with a selected amount of a feed intake inhibitor. The inhibitor comprises a source of hop solids. The intake is detectably inhibited relative to intake by the same or a similar livestock animal when an amount of feed supplement offered the animal in the absence of the feed intake inhibitor is identical to the first amount of feed supplement in the mixture offered the animal, and the animal consumes less of the feed supplement from the mixture than of the feed supplement alone over a given time period.

In an exemplary embodiment, the method further comprises combining the feed intake limiter with livestock feed. In various embodiments, the resulting combination is fed to livestock. In exemplary embodiments, the presence of the feed intake inhibitor reduces the feed supplement intake of the animal over a given time period by at least about 5%, at least about 10%, at least about 20%, at least about 30%, at least about 40% or at least about 50% of the corresponding feed intake of a substantially identical animal to which the feed limiter is not administered. In an exemplary embodiment, the feed supplement intake reduction is measured on a per day basis. In various embodiments, the feed supplement intake reduction is measured on a per offering of the feed supplement basis. In an exemplary embodiment, the mass of the feed supplement intake is determined.

In an exemplary embodiment, this reduced intake is achieved with low inclusion of the hop solids, e.g., debittered hop cones, (e.g., about 0.5% (wt/wt) to about 15% (wt/wt), e.g., from about 2% (wt/wt) to about 10% (wt/wt)), inclusion in the offered feed supplement. In various embodiments, feed intake is reduced by a selected level at hop solids, e.g., debittered hop cone, inclusion not greater than about 10% (wt/wt) of the weight of the offered feed supplement.

Also provided is a means of assessing the effectiveness of the animal feed intake limiter at limiting intake. Thus, in an exemplary embodiment, the animal is fed livestock feed supplement without the feed intake limiter. The animal (or a similar animal) is separately fed a feed supplement containing the feed intake inhibitor and the difference in feed supplement intake over a given time period is assessed as a measure of the effectiveness of the animal feed intake inhibitor. “A substantially similar animal,” as used herein, refers to an animal of the same species, breed, level of maturity, weight, biological status (e.g., pregnant, nursing, etc.), and physical location (e.g., pasture, feeding facility, etc.). Determining when two livestock animals are “substantially similar” is within the ability of one of ordinary skill in the art.

In exemplary embodiments, the presence of the feed intake inhibitor reduces the feed intake of the animal over a given period of time by at least about 5%, at least about 10%, at least about 20%, at least about 30%, or more of the corresponding feed intake of a livestock animal to which the feed limiter is not administered. In an exemplary embodiment, this is the result though less feed limiter is added to the feed supplement than the amount of reduction in consumption. For example, in one embodiment, a feed supplement containing 10% (wt/wt) of the feed limiter results in about a 15%, about a 20%, about a 25%, or greater reduction in the amount (e.g., mass) of feed supplement consumed by an animal over a given period of time.

In some embodiments, the animal's feed intake in the presence of the feed intake inhibitor is reduced by from about 10% to about 20% compared to the intake without the presence of the feed intake limiter. In some embodiments, this is the result though less than from about 10% to about 20% of feed intake limiter is added to the feed supplement.

The invention is not limited by the type of animal to whom the feed intake limiter is fed. In an exemplary embodiment the livestock is a ruminant, e.g., cattle, deer, or goats.

In various embodiments, a predetermined amount of feed supplement may be consumed by the animal to provide the desired amount of nutritional material with intake being regulated by inclusion of the feed intake limiter of the invention. The amount consumed will vary, of course, depending upon the type of feed supplement to which the invention is applied. For example, cattle feed supplements containing the feed intake inhibitor will, in some embodiments, be consumed by the animal in amounts of less than about 6 pounds of supplement per animal per day, preferably about 4 pounds or less, or from about 2 to about 4 pounds per animal per day. In an exemplary embodiment, the amount of feed supplement intake represents a reduction in the amount the same (or a similar) animal would consume per time period, or offering, without the feed intake limiter present in the feed supplement.

In an exemplary embodiment, consumption of solid supplements containing the feed intake limiter of the invention, such as blocks, meal, and pellets, will generally be consumed by the animal in an amount from about 1 to about 6 pounds per animal per day. In various embodiments, more complete rations, such as dairy meal and the like containing the feed limiter of the invention, may be consumed in amounts up to about 8 pounds or more per animal per day.

### C. Instructions

Various embodiments of the invention include instructions for practicing the respective embodiment, e.g., making the feed intake limiter, combining the feed intake limiter with a feed supplement, feeding the feed intake limiter and/or feed supplement and feed intake limiter to an animal, feeding an animal the feed intake limiter and a feed supplement such that the feed intake, animal weight gain or both is controlled to a desired level, and the kits disclosed herein. The instructions can be in tangible written form or can be distributed over a network, e.g., a local network or a distributed network, e.g., the world wide web.

In an exemplary embodiment, the instructions are distributed over a network and the invention provides a computing system comprising one or more processors and a memory, the memory storing one or more programs for execution by the one or more processors, the one or more programs singularly or collectively comprising instructions for executing a method comprising: receiving a request from a user remote to the computing system over an Internet connection; responsive to the request, providing a first instruction, wherein the first instruction comprises instructions for performing one or more methods of the invention as set forth herein.

Each of the terms used in conjunction with describing the instructions of the invention have their generally art-recognized meaning.

### III. Exemplary Embodiments

In various embodiments, the invention provides:

A method of inhibiting feed supplement intake by a livestock animal, the method comprising: feeding the animal a mixture of a first amount of the feed supplement and a first amount of a feed intake inhibitor, the feed intake inhibitor comprising a source of hop solids, thereby inhibiting the feed supplement intake relative to intake of a second amount of the feed supplement alone without the limiter by the same or a similar animal over a given period of time.

A method according to the preceding paragraph, wherein the first and second amount of feed supplement are the same amount.

The method according to any preceding paragraph, wherein the inhibiting is of an amount greater than the selected amount of feed intake inhibitor.

The method according to any preceding paragraph, wherein the inhibiting is of an amount greater than the selected amount of feed intake inhibitor, wherein the inhibiting is measured in percent reduction of intake, and the amount of feed intake inhibitor is measured in (wt %) of the mixture of the feed supplement and the feed intake inhibitor.

The method according to any preceding paragraph, wherein the inhibiting is a reduction in intake by the animal of from about 5% to about 30% of the feed supplement per offering to the animal of the feed supplement relative to the intake of the second amount of the feed supplement alone without the limiter by the same or the similar animal.

The method according to any preceding paragraph, wherein degree of the inhibiting is determined by comparing the intake of feed supplement by the animal from the mixture of the feed supplement and the feed inhibitor with the intake of the feed supplement alone by the same or the similar animal.

The method according to any preceding paragraph, wherein the source of hop solids is mixed with from about 0.5% to about 50% (wt/wt) of hop extract, the extract comprising from about 20% to about 40% (wt/wt) hop oils.

The method according to any preceding paragraph, wherein the source of hop solids is debittered hop cones.

The method according to any preceding paragraph, wherein the hop extract is oil enriched hop extract.

The method according to any preceding paragraph, wherein the selected livestock animal is a ruminant.

The method according to any preceding paragraph, wherein the ruminant is selected from cattle, deer, and goats.

A kit for use in the method according to any preceding paragraph, the kit comprising: (a) the first amount of the feed limiter; and (b) instructions for mixing the first amount of the feed limiter with a measured amount of the feed supplement.

The kit according to paragraph [00101] for use in the method according to any of paragraphs [0090]-[00100], wherein the instructions direct the user to select a determined inclusion level of the feed inhibitor in the feed supplement to achieve a desired level of the inhibiting.

The kit according to paragraphs [00101]-[00102] for use in the method according to any of paragraphs [0090]-[00100], further comprising: (c) a determined amount of feed to be mixed with the first amount of the feed limiter.

The kit according to paragraphs [00101]-[00103] for use in the method according to any of paragraphs [0090]-[00100], wherein the animal feed is provided in a second measured amount corresponding to the measured amount of the feed limiter such that the feed limiter and the feed are mixed in their entirety without requiring measurement, wherein the second measured amount is a feed intake limiting amount.

The kit according to paragraphs [00101]-[00104] for use according to any of paragraphs [0090]-[00100], wherein the instructions state that the feed intake limiter is GRAS, approved by FDA as a food additive, approved by the American Association of Feed Control Officials (AAFCO) or a combination thereof.

The kit according to paragraphs [00101]-[00105] for use in the method according to any of paragraphs [0090]-[00100], wherein the instructions direct a user to administer to the livestock animal an amount of the feed intake limiter sufficient to reduce the feed supplement intake of the animal by from about 5% to about 30% relative to the feed supplement intake of the same animal or the similar animal not administered the feed intake limiter.

The kit according to paragraphs [00101]-[00106] for use in the method according to any of paragraphs [0090]-[00100], wherein the instructions direct a user to administer to the livestock animal an amount of the feed intake limiter sufficient to reduce the feed supplement intake of the animal by at least about 10% relative to the food intake of the same or the similar animal not administered the feed intake limiter.

A kit according to paragraphs [00101]-[00107] for use in the method according to any of paragraphs [0090]-[00100], the kit comprising: (a) the first amount of the feed limiter; and (b) instructions for mixing the first amount of the feed limiter with a measured amount of the feed supplement.

The kit according to paragraphs [00101]-[00108] for use in the method according to any of paragraphs [0090]-[00100], wherein the hop oils are selected from the monoterpene myrcene, the sesquiterpenes humulene and caryophyllene, other terpene-derived components and a combination thereof.

The kit according to paragraphs [00101]-[00109] for use in the method according to any of paragraphs [0090]-[00100], wherein the hop oil is present in the feed intake limiting component in an amount of from about 0.50% (w/w) to about 50% (w/w) of the feed intake limiter.

The kit according to paragraphs [00101]-[00110] for use in the method according to any of paragraphs [0090]-[00100], wherein the hop oil is present in the feed take limiting component in an amount of from about 2.5% (w/w) to about 7.5% (w/w) of the feed intake limiter.

The kit according to paragraphs [00101]-[00111] for use in the method according to any of paragraphs [0090]-[00100], wherein the hop oil is present in the feed take limiting component in an amount of about 5% (w/w) of the feed intake limiter.

The kit according to paragraphs [00101]-[00112] for use in the method according to any of paragraphs [0090]-[00100], wherein the source of hop solids is debittered hop cones.

The kit according to paragraphs [00101]-[00113] for use in the method according any of paragraphs [0090]-[00100], wherein the feed limiter is formed by a method comprising: (a) contacting the source of hop solids with the hop extract, at least partially coating the hop solids with the hop extract.

The kit according to paragraphs [00101]-[00114] for use in the method according to paragraph [00114], further comprising: (b) prior to step (a), liquefying the hop extract by heating.

The kit according to paragraphs [00101]-[00115] for use in the method according to any of paragraphs [00114]-[00115], wherein the hop extract is liquefied by heating it to a temperature of from about 40° C. to about 80° C.

The kit according to paragraphs [0090]-[00116] for use in the method according to any of paragraphs [00114]-[00116], wherein the contacting includes mixing the source of hop solids and the liquified hop oil extract in a mixer tumbler.

The kit according to paragraphs [0090]-[00117] for use in the method according to any of paragraphs [00114]-[00117], wherein the mixing occurs for a period of from about 5 mins to about 20 mins.

The kit according to paragraphs [0090]-[00118] for use in the method according to any of paragraphs [00114]-[00118], wherein the source of hop solids is debittered hop cones and the hop extract is oil enriched hop extract.

An animal feed intake limiter comprising a feed intake limiting amount of a hop-based feed intake limiting component, the feed limiting component comprising: a source of hop solids, e.g., debittered hop cones, mixed with from about 0.5% to about 50% (wt/wt) of hop extract, the extract comprising from about 25% to about 40% (wt/wt) hop oils, wherein an exemplary hop extract is an oil enriched hop extract.

The animal feed intake limiter of paragraph [00120], wherein the hop oils are selected from the monoterpene myrcene, the sesquiterpenes humulene and caryophyllene, other terpene-derived components, or a combination thereof.

The animal feed intake limiter of any of paragraphs [00120]-[0121], wherein the hop oil is present in the feed intake limiting component in an amount of from about 1% (w/w) to about 15% (w/w) of the feed intake limiter.

The animal feed intake limiter of any of paragraphs [00120]-[0121], wherein the hop oil is present in the feed take limiting component in an amount of from about 2.5% (w/w) to about 7.5% (w/w) of the feed intake limiter.

The animal feed intake limiter of any of paragraphs [00120]-[0121], wherein the hop oil is present in the feed take limiting component in an amount of about 5% (w/w) of the feed intake limiter.

The animal feed intake limiter of any of paragraphs [00120]-[0121], wherein the hop solids are pelletized.

Instructions for practicing any method set forth herein, wherein the instructions are located on a computer readable medium selected from a non-transitory computer readable medium, a local network, distributed on the world wide web, and a combination thereof.

The following Examples are offered to illustrate exemplary embodiments of the invention and do not define or limit its scope.

### EXAMPLES

### Example 1

### 1.1. Product A (Debittered Hop Pellets)

Debittered Hop Pellets were produced from raw hop cones (the cones from the female vines of Humulus lupulus) a raw agricultural commodity. The raw hop cones were ground to a powder at freezing temperature and pelletized into pellets. The pellets were subsequently extracted with supercritical CO₂.

### 1.2. Product B (Debittered Hop Pellets+Oil Enriched Hop Extract, Animal Feed Intake Limiter)

Oil enriched hop extract is generated during advanced hop processing. It is a resinous material that typically contains from about 20% to about 40% hop oils, with the remainder of the composition being hop resins. The majority of the hop oil is comprised of the monoterpene myrcene and the sesquiterpenes humulene and caryophyllene, with smaller amounts of other terpene-derived components. Oil enriched hop extract is routinely generated from high-alpha hop extracts. Oil enriched hop extract is typically added during kettle boil to provide a background hop character or “kettle hop” flavor.

### 1.3. Manufacturing Process for Animal Feed Intake Limiter (Product B)

Oil enriched hop extract was heated to 50-80° C. to liquefy it. The liquid was combined with debittered hop pellets in a mixer tumbler and mixed for approximately 10 minutes. The oil enriched hop extract was added to the debittered hop pellets at 5% inclusion rate but can be added in the range from about 0.5 to about 50% (wt/wt), e.g., from about 1% to about 40%, from about 5% to about 25%, from about 10% to about 20%.

### Example 2

### 2.1. Feed Inhibitor: 0.5% Inclusion, 3 Cattle in Pasture

Control: sweet feed. The animals consumed the sweet feed immediately. This was typical for a non-experimental day.

Day 1: Offered at 2 pounds per head (Mixed 0.5% of Product B into Sweet Feed); consumed it all, taking over an hour.

Day 2: Offered at 2 pounds per head (Mixed 0.5% of Product B into Sweet Feed) ate all immediately.

Day 3: Offered at 2 pounds per head. Increased the inclusion rate to 1%; consumed all immediately.

Interpretation: The feed intake limiter inclusion weight may not be high enough.

### 2.2 Feed Inhibitor: 5% Inclusion (Increased the Inclusion to 5%) in Sweet Feed.

Day 1. The cattle left ½ pound out of six total pounds (2 pounds per head) after 1 hour. Of three feed trays with 2 pounds each, 2 were finished, and one was left with ½ pound. The other animals had access to the remaining ½ pound but moved away on pasture.

Interpretation: The animals leaving any sweet feed remaining after 1 hour were judged to show feeding inhibition. The decision was made to maintain feeding at 5% inclusion of feed intake inhibitor in sweet feed for another 2 days.

Day 2: Same protocol. Animals smelled the sweet feed with 5% inclusion of feed intake limiter and only started eating very slowly; all sweet feed with feed intake limiter was eaten within one hour.

Days A-D (Trials with Commercial all-Stock Feed)

Methods: 5% mix of feed inhibitor with all stock feed. This is not a sweet feed, just a low-cost pelleted product suitable for cattle. Three feeding trays with 5 pounds each tray, a total of 15 pounds, were offered for 2 hours.

Day A: A portion of the offered all stock feed and feed limiter was left in each tray. 1 pound was left in two trays and 2½ pounds in the third tray. The total amount of the mixture consumed was 10½ pounds across all three trays. 4½ pounds of the mixture was left after 2 hours. Once again, the presence of the feed intake limiter clearly inhibited consumption and also significantly slowed the rate of feed supplement intake. After a few initial mouthfuls, the cattle were observed to slow their rate of feed intake, to walk away from the feed trays, and then return for more feed supplement.

Day B: 15 pounds of straight (0% feed inhibitor) all stock feed supplement was offered to compare intake for 2 hours, and to assess how quickly the cattle consume all 15 pounds. All offered feed supplement was consumed within 10 minutes. This was the expected result from offering free choice all stock feed.

Day C: 5% inclusion of Product B. 15 pounds of all stock feed including 5% of the feed intake limiter was offered the cattle at 5 lbs/head. After 2 hours, 5%2 pounds were left, 9%2 pounds consumed. This was a 37% reduction in intake after 2 hours, instead of all feed supplement being eaten within minutes as on Day C.

Day D: This experiment repeated the Day C protocol; 15 pounds (0% feed inhibitor) in all stock feed. All of the feed was consumed within 11 minutes.

Having been given the teachings of this invention other advantages and modifications will occur to those working in this field. In the case of beef animals, it is more desirable to raise the animal so that it eats on a twenty-four-hour feeding schedule rather than on one or two feedings per day. Referring now to modifications, the invention herein is operable in a wide variety of feeds including corn-dry processed, high moisture and steam flaked, milo-dry rolled, steam flaked and high moisture, wheat-dry rolled, steam flaked, oats-dry rolled, barley-dry rolled, wheat middlings, and corn gluten feed-wet and dry. Such modifications are within the skill of the art.

What is claimed is:

1. An intake self-limiting animal feed supplement comprising a mixture of:
(a) a feed supplement component; and
(b) a feed intake limiting component comprising hop solids, wherein the feed supplement component and the feed intake limiting component are mixed together, forming the intake self-limiting animal feed supplement.

2. The intake self-limiting animal feed supplement of claim 1, wherein the feed supplement component is selected from grains, legumes, nuts, seeds and a combination thereof.

3. The intake self-limiting animal feed supplement of claim 1, wherein the hop solids are selected from spent hops from CO₂ extraction, spent hops from enriched hop pellet manufacturing, hop pellets and a combination thereof.

4. The intake self-limiting animal feed supplement of claim 1, wherein the hop solids are debittered hop cones.

5. The intake self-limiting animal feed supplement of claim 1, wherein the hop solids are present in an amount of from about 0.5% (wt/wt) to about 25% (wt/wt) of the self-limiting animal feed supplement.

6. The intake self-limiting animal feed supplement of claim 5, wherein the hop solids are present in an amount of from about 1% (wt/wt) to about 15% (wt/wt) of the self-limiting animal feed supplement.

7. The intake self-limiting animal feed supplement of claim 1, wherein the feed intake limiting component comprises a hop extract mixed with the hop solids.

8. The intake self-limiting animal feed supplement of claim 7, wherein the hop extract is present in the feed intake limiting component in an amount of from 0.5% (w/w) to about 50% (w/w) of the feed intake limiting component.

9. The intake self-limiting animal feed supplement of claim 7, wherein the hop extract comprises hop oils.

10. The intake self-limiting animal feed supplement of claim 9, wherein the hop extract comprises from about 20% (wt/wt) to about 40% (wt/wt) hop oils.

11. A method of limiting feed supplement intake by an animal, the method comprising feeding the animal a feed intake limiting amount of the intake self-limiting animal feed supplement of claim 1.

12. The method according to claim 11, wherein the feed supplement intake by the animal over a time period is reduced by from about 5% to about 30% relative to the feed intake of a substantially similar animal over the time period, wherein the substantially similar animal is not fed the intake self-limiting animal feed supplement.

13. The method of claim 12, wherein the animal is offered a first amount of a first feed supplement wherein the first feed supplement is in combination with the feed intake limiting component, and the similar animal is offered a substantially identical first amount of a substantially identical feed supplement from which the feed intake limiting component is absent, each feed supplement offered for the given time.

14. A kit for making the intake self-limiting animal feed supplement of claim 1, the kit comprising:
(a) the feed intake limiting component comprising hop solids; and
(b) instructions for combining the feed intake limiting component and the feed supplement to make the intake self-limiting animal feed supplement.

15. The kit according to claim 14, further comprising:
(c) the feed supplement.

16. The kit according to claim 14, wherein the instructions direct the user on a mixing the feed intaking limiting component and the feed supplement in a ratio selected to achieve a selected reduction in feed supplement intake by the animal.

17. The kit according to claim 14, wherein the instructions direct the user on a mixing the feed intaking limiting component and the feed supplement in a ratio selected to achieve a selected reduction in feed supplement intake by the animal within the given time period.

18. A method of preparing the intake self-limiting animal feed supplement of claim 1, the method comprising, combining a first selected amount of the feed supplement component and a first selected amount of the feed intake limiting component, thereby forming the intake self-limiting animal feed supplement.

19. Instructions directing a user on practicing the method according to claim 18.

20. The instructions according to claim 18, wherein the instructions are located on a computer readable medium selected from a non-transitory computer readable medium, a local network, distributed on the world wide web, and a combination thereof.
